(19) United States
(12) Patent Application Publication
(10) Pub. No.: US 2011/0116540 A1
(43) Pub. Date: May 19, 2011

(54) Multimedia Content Handling in a Home-Network System

(75) Inventors: Jay O'Connor, Chicago, IL (US); Faisal Ishtiaq, Chicago, IL (US)

(73) Assignee: GENERAL INSTRUMENT CORPORATION, Horsham, PA (US)

(21) Appl. No.: 12/620,867

(22) Filed: Nov. 18, 2009

(51) Int. Cl. H04N 11/02; H04N 5/445

(52) U.S. Cl. 375/240.02; 375/240.26; 725/54; 725/80; 375/E07.152

(57) ABSTRACT

A method of handling multimedia digital content in a network that interconnects diverse electronic devices is provided. Multimedia digital content with associated metadata is acquired by a device on the network from a source, and characteristics of a target device on which the multimedia digital content is to be played are obtained. At least one or both of the metadata of the multimedia digital content and the characteristics of the target device are analyzed for determining rules or parameters for encoding the source multimedia digital content. After the analyzing and determining steps, the source multimedia digital content is encoded with the determined rules or parameters and the encoded multimedia digital content is transmitted to the target device. Accordingly, the encoding step produces a content adaptation that is specifically optimized for playback on the target device. A Media Interoperability Unit (MIU) and a Digital Living Network Alliance (DLNA) system are also provided.

### FIELD OF THE INVENTION

Media content handling and adaptation in a network system, such as a home-network system to which diverse electronic devices are connected, is disclosed, and more particularly, the handling and optimized adaptation of source digital multimedia content having associated metadata within a Digital Living Network Alliance (DLNA) or like system is disclosed.

### BACKGROUND OF THE INVENTION

The Digital Living Network Alliance (DLNA) is a home entertainment protocol permitting seamless sharing of digital media content, such as photographs, music, and video, between many different diverse electronic devices interconnected via a home network. The home network may be a local area network (LAN) or any other local or remote network on which a DLNA system can function and reside.

The DLNA provides a standard for controlling the sharing of media content between electronic devices such as consumer electronic devices (HDTVs, home theater systems, home music systems, set-top boxes, game consoles, digital photo frames, appliances, etc.), computer related devices (desktop computers, laptop computers, cable/Internet modems, home gateways, routers, etc.), and mobile devices (hand-held devices, mobile phones, communication devices, digital cameras, MP3 players, etc.). Thus, DLNA enables digital media content stored on, or acquired by, one electronic device on the home network to be shared by and played on other electronic devices within the home so that a user can enjoy their digital media on any of the electronic devices within the home at any location with the home at any time.

A so-called DLNA “ecosystem” can be constructed of devices from various diverse types of categories, such as Digital Media Server (DMS), Digital Media Player (DMP), Digital Media Renderer (DMR), Digital Media Controller (DMC), Mobile Digital Media Uploader (M-DMU), Mobile Digital Media Downloader (M-DMD) and Media Interoperability Unit (MIU) to name a few. A DMS is a component capable of acquiring, recording, storing and sourcing digital media content (for instance, a set-top box, PC Server, etc.); a DMP is a component capable of finding and acquiring media from a DMS and playing the media (for instance, a high definition television); a DMR has the ability to display content provided to it by another device (i.e., a passive DMP); and a DMC is a component that initiates activities as a third-party controller, for instance, to start a display of media from a DMS to a DMR. A M-DMU is a mobile device that sends content to the server (for instance, a digital camera or camcorder); a M-DMD is a mobile device that receivers content from the server (for instance, a hand held device with a display screen); and a MIU is a component of the DLNA that provides media content format conversions between the various home network devices and mobile devices.

Accordingly, the MIU is a media transformation device and permits diverse electronic devices to connect and talk seamlessly with each other thereby enabling a consumer to share multimedia content seamlessly without the need to manually setup and configure such devices. The MIU is assigned a content adaptation function, for instance, so that source content for non-mobile devices can be played on mobile devices. However, known content adaptations performed by conventional MIUs are considered inefficient since content encoding is typically accomplished with the same pre-set parameters regardless of type of content and without respect to target playback device characteristics. Simply by way of example, broadcast coding specifications are very specifically designed for cable/IPTV infrastructure such as high definition televisions and have never been designed to be viewed by certain devices in a DLNA ecosystem, such as on small display screens of hand-held mobile devices.

Further, the use of portable and/or mobile electronic hand-held electronic devices in a DLNA ecosystem and the demand for video enabled mobile devices continue to increase. However, video processing requires a significant amount of signal processing and places high demands on mobile devices having limited computational power and battery life. In some cases, a mobile device can receive video content that cannot be reliably played due to mobile device constraints such as data rate. Other mobile devices may have significant resources that are simply not utilized based on the particular encoding scheme used by the MIU which typically targets the least common denominator.

### SUMMARY OF THE INVENTION

A method of handling multimedia digital content in a network that interconnects diverse electronic devices is provided. Multimedia digital content with associated metadata is acquired by a device on the network from a source, and characteristics of a target device on which the multimedia digital content is to be played are obtained. At least one or both of the metadata of the multimedia digital content and the characteristics of the target device are analyzed for determining rules or parameters for encoding the source multimedia digital content. After the analyzing and determining steps, the source multimedia digital content is encoded according to the determined rules or parameters and the encoded multimedia digital content is transmitted to the target device. Accordingly, the encoding step produces a content adaptation that is specifically optimized for playback on the target device.

The above referenced method is particularly suited for a Digital Living Network Alliance (DLNA) system residing on a home network, such as a LAN or any other local or remote network, in which the target device is a battery-operated hand-held video-enabled mobile device. According to one contemplated embodiment, the source multimedia digital content is a television program and the associated metadata is content metadata from an Electronic Program Guide (EPG). Thus, according to this embodiment, a type of content indicated by the metadata is the type of television program, and this information is used to determine an optimized adaptation of the multimedia digital content wherein the rules or parameters determined from the metadata include optimized settings for the encoded content including at least one of frame rate, spatial quality and bit-rate.

In addition, a Media Interoperability Unit (MIU) for a Digital Living Network Alliance (DLNA) system is provided. The MIU has a decision handling unit for receiving content metadata corresponding to source multimedia digital content and for analyzing the content metadata and determining rules or parameters for use in encoding the source multimedia digital content. The MIU also has a content adaptor for encoding the source multimedia digital content based on the rules or parameters determined for the source multimedia digital content by the decision handling unit. The decision handling unit and content adaptor may be implemented in software on a processor, a microprocessor, or a digital signal processor or in the form of hardware.

Still further, a Digital Living Network Alliance (DLNA) system is provided. The DLNA system has at least one Digital Media Server (DMS) for acquiring source multimedia digital content having associated content metadata and at least one battery-operated, video-enabled, mobile device connected to the network and capable of receiving and playing multimedia digital content. The DLNA system also includes a Media Interoperability Unit (MIU) for acquiring the source multimedia digital content and associated content metadata from the DMS and for transmitting an encoded adaptation of the source multimedia digital content to the mobile device. The MIU has a decision handler for analyzing the content metadata and determining rules or parameters based on the content metadata for use in encoding the source multimedia digital content and a content adaptor for encoding the source multimedia digital content based on the rules or parameters determined for the source multimedia digital content by the decision handling unit.

### BRIEF DESCRIPTION OF THE DRAWINGS

Various features of the embodiments described in the following detailed description can be more fully appreciated when considered with reference to the accompanying figures, wherein the same numbers refer to the same elements.

FIG. 1 illustrates a simplified schematic view of a possible DLNA system arrangement of diverse electronic devices;

FIG. 2 illustrates a simplified schematic view of one contemplated embodiment of a MIU of the DLNA system according to the present invention; and

FIG. 3 illustrates a flow chart with respect to a method of handling multimedia digital content in a DLNA system according to the present invention.

### DETAILED DESCRIPTION OF THE INVENTION

For simplicity and illustrative purposes, the principles of the embodiments are described by referring mainly to examples thereof. In the following description, numerous specific details are set forth in order to provide a thorough understanding of the embodiments. It will be apparent however, to one of ordinary skill in the art, that the embodiments may be practiced without limitation to these specific details. In some instances, well known methods and structures have not been described in detail so as not to unnecessarily obscure the embodiments.

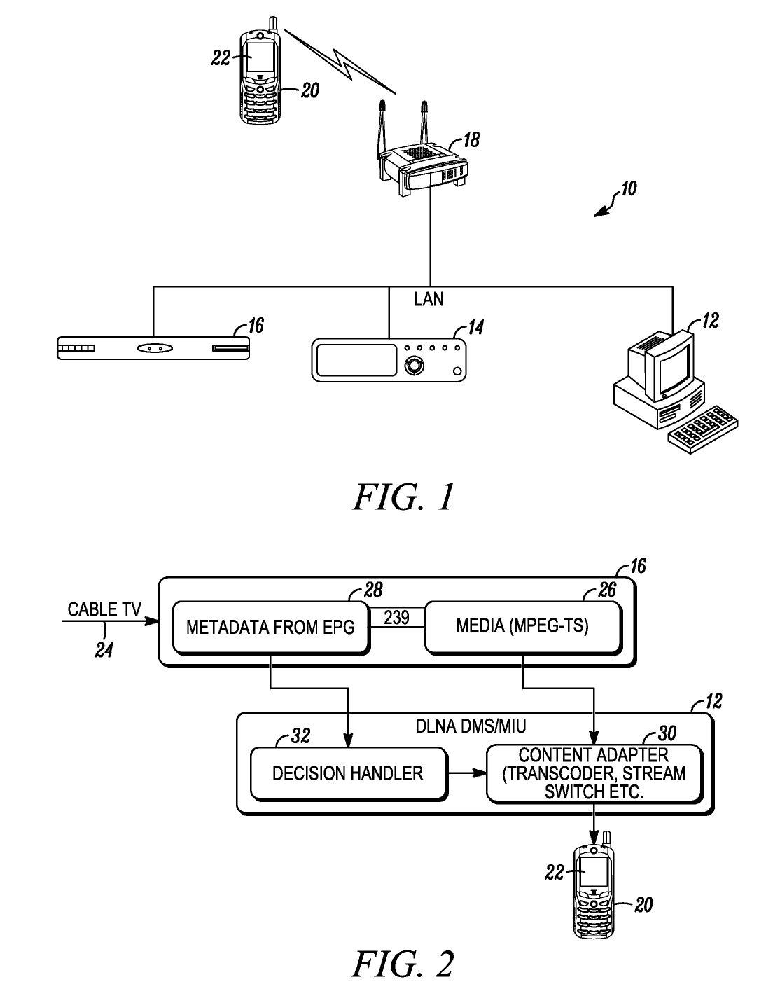

FIG. 1 illustrates an example of a simplified local area network (LAN) 10 on which a DLNA system resides. It should be noted that many other devices not shown in FIG. 1 can be connected to the network 10, including remote networks, and that FIG. 1 is presented merely for purposes of example and not by way of limitation. In the illustrated embodiment, the network 10 includes a personal computer 12 providing the function of both a DMS and MIU for the DLNA system. The network 10 also includes an additional electronic device 14 such as a digital video recorder (DVR) functioning as both a DMC and DMS, a set-top box 16 receiving cable television programming, and a wireless router 18 communicating with a battery-operated mobile device 20. The mobile device 20 can be any type of hand-held device that may include digital camera capabilities and a small display screen 22 on which still images and multimedia video can be displayed.

In accordance with DLNA system operations, a consumer can transfer images, videos, audio, music or like content from the mobile device 20 for playback, storage, or viewing on the computer monitor (not shown) associated with the personal computer 12 or a high definition television (not shown) or the like associated with one of the set-top box 16 or digital recording device 14. In this case, the media content is uploaded seamlessly from the mobile device 20 via the router 18 to the DMS/MIU in the personal computer 12. If necessary, the DMS/MIU transforms the media content into a form capable of being played and/or displayed on any of the other electronic devices on the network 10.

Likewise, if source content media is stored on or received by the personal computer 12 via the Internet or the like or the digital recording device 14 or the set-top box 16 via connection to a cable or satellite television network connection, it can be played on any home electronic device and/or mobile device that is properly connected to the home network 10. For example, a television program received by set-top box 16 via a cable TV connection can provide multimedia content that is encoded by the MIU 12 for being stored on and/or played and viewed on the screen 22 of the mobile device 20.

Obviously, different mobile devices 20 have different capabilities and different characteristics which will ultimately affect the quality and efficiency of playback on the mobile device. The mobile device 20 may be constrained from the standpoint of quantity of memory, processing power and/or speed, and battery life. Thus, video quality may or may not be unacceptable depending upon the particular device and video signal. Accordingly, a system which optimizes the function of encoding source multimedia content and content adaptation, particularly with respect to playback on mobile devices in a DLNA system, is sought.

When sharing multimedia content within a DLNA system or the like, it is often necessary to convert or transform some content to a form adapted for playback on any one of a large number of diverse types of electronic devices. Conventional content encoding and adaptation functions have been provided in a DLNA system without respect to the characteristics of the device on which the content will be displayed and without respect to the specific characteristics of the media content itself. However, according to the embodiments herein, the encoding function is optimized by a MIU that takes into consideration at least one of metadata of the media content and device characteristics when encoding content. In this manner, source media content originally intended for playback on one type of electronic device can be played efficiently on a diverse type of electronic device, perhaps on a device on which playback was never originally intended or on a device that has limited memory, processing resources and/or battery life.

According to one embodiment, source multimedia digital content is received by the set-top box 16 (or other DMS 14) as shown in FIG. 2. The source multimedia digital content in this particular example is originally intended for display on a large screen HDTV or other similar DMP or DMR (not shown). Such a DMP or DMR may be directly interconnected to a power supply and may have significant signal processing and memory resources readily capable of handling the source multimedia digital content which may certainly be provided in a high definition format.

If required, the MIU 12 provides the network 10 with a means of encoding and adapting the source multimedia digital content so that the multimedia content can be played on the mobile device 20 which likely will have a significantly smaller display screen 22 with reduced resolution capabilities and which likely will have limited resources with respect to signal processing, memory and power. By way of example, the display screen 22 can be part of a battery-powered PDA, mobile phone, or like hand-held video-enabled mobile device.

The MIU 12 is specifically designed to receive and analyze metadata associated with the source multimedia digital content. Metadata is data, information, parameters and the like about other associated data, such as media content. Multimedia digital content will have associated metadata embedded within the multimedia file or separate from the file. For instance, the metadata may provide information concerning the type, title, duration, date, category, playback parameters, or any other information or parameter concerning the media content.

A specific example of metadata which typically is present within a DLNA system is content metadata provided by Electronic Program Guides (EPG) used by television program delivery systems or networks, such as cable or satellite television networks. When a digital television program is delivered to a set-top box or like DMS, it is required to have certain metadata information associated with it that enables the receiver of the set-top box to extract information concerning the tuned-station and program. For example, this data can include tuning information, frequency, MPEG program number, title, rating, content warnings, actors, program description, director, reviews, closed caption information, broadcast time, broadcast channel, duration, category and subcategory of program, video and audio parameters, and the like. Video content parameters can include, for example, information concerning display type (i.e., letterbox, wide screen, high definition, etc.), frames per second, visual quality, spatial resolution, PSNR, minimum and maximum bit-rates, length of encoded content, buffer management, and decoded playback, and audio parameters can include language, stereo, surround sound, Dolby, Dolby 5.1, or the like. The metadata facilitates watching, searching, and recording programs and permits a viewer to browse program summaries and search or sort by genre, title and/or channel.

As best illustrated in FIG. 2, the above referenced metadata is used to optimize content encoding and adaptation for purposes of playing the associated multimedia content on a mobile device 20. In FIG. 2, the set-top box 16 receives a signal with respect to source multimedia digital content from a cable TV supplier via cable 24. The receiver of the set-top box 16 receives the source media digital content 26 (such as in a MPEG-TS format) and its associated metadata 28 from EPG. In the embodiment illustrated in FIG. 2, both the metadata 28 and source media digital content 26 are provided to the DMS/MIU 12 of the DLNA system. In this case, a personal computer 12 connected to the network 10 provides a DMS/MIU 12. As an alternative, the MIU can be a stand-alone black box device or can be incorporated into any other device connected to the network, such as a set-top box, computer, DVR, router, home gateway, mobile device, or the like.

The MIU 12 includes a content adaptor 30 for receiving the source multimedia digital content 26 and for adapting the content for playback on diverse types of electronic devices. For example, the content encoded by MIU 12 can be in a form for playback on the small display screen 22 of the specific mobile device 20 shown in FIG. 2. The content adaptor 30 can include a transcoder, stream switch, and like electronic components typically utilized by such an adaptor 30. However, unlike conventional MIUs which apply the same encoding rules/parameters for every encoding procedure regardless of content and regardless of playback device, the MIU 12 includes a decision handling unit 32 which pre-sets the rules and parameters for each content adaptation of the adaptor 30 that best optimizes the adaptation. Thus, the rules are adjusted and changed depending upon media content and/or the device for which the content is being encoded for playback.

For example, the decision handling unit 32 is provided with the metadata 28 and with characteristics previously obtained by the MIU 12 for all devices on the network 10. Based on this information, the decision handling unit 32 determines via algorithms, look-up tables, or the like, how the content adaptor 30 should encode the source multimedia digital content 26 so that optimum playback can be accomplished with respect to the particular mobile device 20 for the particular content.

Accordingly, the decision handling unit 32 of the MIU 12 intelligently decides the method and rules of adaptation of the source multimedia digital content. The unit 32 considers the supported input and output profiles and the characteristics of the rendering device. In addition, the content is adapted using parameters appropriate to the specification of the metadata. This is best explained via the following example.

Based on conventional practice, video programs of sports, action films, romantic comedies, cartoons, etc. have all been encoded using the same parameters. This also applies to audio content, for instance, orchestral performances are encoded the same as audio content of talk radio shows. It should also be noted that broadcast coding specifications, such as provided for cable TV programming, has traditionally never been designed for playback on small screens of mobile devices and the like. For the above reasons, the conventional MIU generates inefficient encoding. One set of encoding rules applies to all content and for all devices.

However, the MIU 12 illustrated in FIG. 2 takes into consideration the type of program of the source multimedia digital content 26 via use of the metadata 28. For example, sports programs and action films may require greater frame rate and less spatial quality to achieve a specific bit-rate that optimize playback on a small hand-held screen 22. Accordingly, the metadata 28 is used as a source of information provided to the decision handling unit 32 so that the decision handling unit 32 can instruct the content adaptor 30 to apply an appropriate set of encoding rules and parameters. In contrast, the video of romantic comedies and cartoons typically have less motion relative to sports videos and actions films. Thus, source video contents of romantic comedies and cartoons can be encoded with higher spatial quality and lower frame rate to optimize playback on a small hand-held screen. This can be accomplished automatically by the decision handling unit 32 of the MIU 12 based on the metadata 28 that it receives in connection with the source content 26 and based on the rules it provides to the content adaptor 30. Of course, these rules can also be determined based on any information provided by the metadata 28, such as genre, length, keywords, and the like.

Also, the MIU 12 of a DLNA system will already have all information concerning the characteristics and capabilities of all electronic devices connected to the network 10. Thus, the decision handling unit 32 of the MIU 12 also takes into consideration this information when providing specific instructions to the content adaptor 30. Depending upon the specific electronic device selected for playback of the source content media 26, the decision handling unit 32 provides adjustments to the content adaptor 30 so that it produces a content adaptation specifically suited for the selected playback device. Thus, the source media content is encoded differently depending upon the type of content (via metadata 28) and the specific characteristics of the device on which the encoded content will be played thereby optimizing playback quality.

An advantage of making adjustments to the content adaptation based on content metadata and/or device characteristics is that the limited recourses of an electronic device, such as a mobile hand-held device, can be better utilized by having it play encoded content specifically adapted to the content type and characteristics of the device. In addition, battery-powered devices, such as mobile devices, can achieve longer battery life by appropriate adjustment of bit-rate, frame rate, and/or resolution of the resulting encoded content. Further, electronic devices on the network 10 having dedicated processing components, such as hardware based decoders, can enable a power savings and provide better user experience when such components are used for signal processing instead of components of devices with more limited resources.

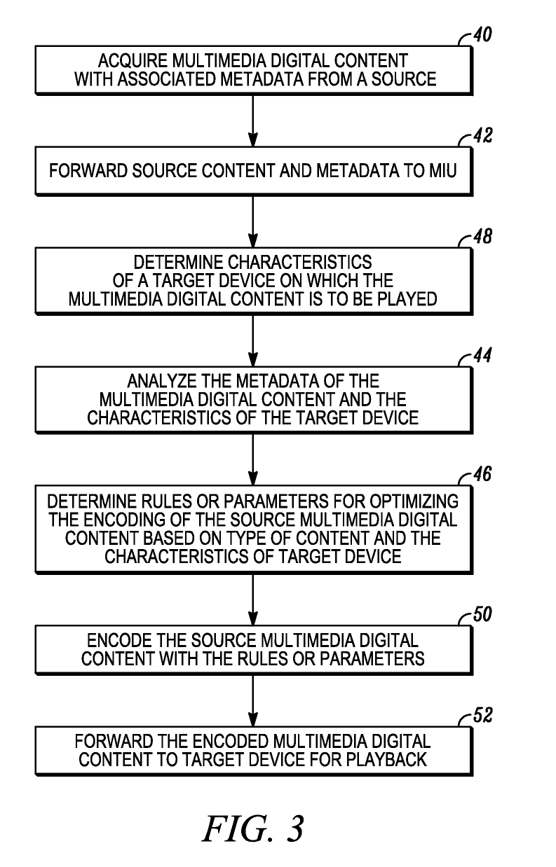

The method steps for optimizing content adaptation via the use of metadata and target device characteristics are best illustrated in FIG. 3. Source multimedia digital content is received by an electronic device on the network (see step 40) and forwarded to the Media Interoperability Unit (MIU) of the DLNA system (see step 42). In this case, the MIU can function as both a Digital Media Server and as a MIU. Of course, the MIU can be a stand-alone device or can be integrated into any type of device on the DLNA system. Purely by way of example, the electronic device originally receiving the source content can be a set-top box or like DMS.

The source multimedia digital content includes both metadata and media content. The metadata is analyzed by a decision handler of the MIU. See step 44. Based on the metadata, the decision handler develops rules or parameters for optimizing content encoding and adaptation. See step 46. For instance, parameters such as bit-rate, spatial quality, frame rate, resolution, display shape and characteristics, stereo, mono, color, etc. are selected by the decision handler. Also, the characteristics of the device on the network to which the encoded content is to be displayed is taken into consideration and appropriate adjustments are made with respect to the rules and/or parameters. See step 48. Thereafter, the rules and/or parameters for encoding the source content are set within the content adaptor of the MIU and the source content media is encoded (see step 50) and then forwarded to the specific device for storage or playback (see step 52). When playback occurs, the video and/or audio are optimized for the specific device and this is all accomplished seamlessly without manual intervention by the viewer.

The MIU and its decision handling unit and content adaptor can be provided by various modules, processors, microprocessors, controllers, units and the like. It will be apparent to one of ordinary skill in the art that the modules, processors, controllers, units and the like may be implemented as electronic components, software, hardware or a combination of hardware and software. For example, the decision handling unit and content adaptor can be implemented in software by a processor such as a microprocessor or a digital signal processor or any other suitable electronic device. The functions of the content adaptor can also be implemented in any suitable hardware. In addition, the decision handling unit and content adaptor can be provided as separate modules within the MIU or can be integrated together such that the one module performs both functions. Also, it will be apparent to one of ordinary skill in the art that the MIU can be a stand-alone device connected to the network or can be integrated into any other device connected to the network. In addition, while an embodiment has been disclosed specifically with respect to a DLNA system, the combination decision handling unit and content adaptor of the MUI can be utilized on other type of system or network in which digital media content is shared among various diverse electronic devices, particularly mobile devices.

While the embodiments have been described with reference to examples, those skilled in the art will be able to make various modifications to the described embodiments without departing from the true spirit and scope. The terms and descriptions used herein are set forth by way of illustration only and are not meant as limitations. In particular, although the methods have been described by examples, steps of the methods may be performed in different orders than illustrated or simultaneously. Those skilled in the art will recognize that these and other variations are possible within the spirit and scope as defined in the following claims and their equivalents.

We claim:

1. A method of handling multimedia digital content in a network interconnecting diverse electronic devices, comprising the steps of:
acquiring multimedia digital content with associated metadata from a source;
determining characteristics of a target device on which said multimedia digital content is to be played;
analyzing the associated metadata of the multimedia digital content provided by said acquiring step or the characteristics of the target device provided by said determining step;
determining rules or parameters for encoding the source multimedia digital content based on said analyzing step;
after said analyzing and determining steps, encoding the source multimedia digital content with the rules or parameters; and
transmitting an encoded multimedia digital content produced by said encoding step to the target device.

2. A method according to claim 1, wherein said encoding step produces a content adaptation that is optimized for playback specifically on the target device.

3. A method according to claim 1, wherein said analyzing step includes analyzing the metadata of the multimedia digital content acquired from the source.

4. A method according to claim 3, wherein the metadata analyzed in said analyzing step relates to the type of content of the source multimedia digital content and wherein different types of content will result in a determination of different rules or parameters used during said encoding step.

5. A method according to claim 3, wherein said analyzing step includes analyzing the characteristics of the target device.

6. A method according to claim 1, wherein the target device is a battery-operated hand-held video-enabled mobile device and wherein the method further comprises the step of playing the encoded multimedia digital content on the mobile device.

7. A method according to claim 1, wherein the source multimedia digital content is a television program and wherein the associated metadata is content metadata from an Electronic Program Guide (EPG).

8. A method according to claim 7, wherein the type of content provided by the metadata is the type of television program, and wherein the rules or parameters determined from the metadata include at least one of frame rate, spatial quality and bit-rate.

9. A method according to claim 1, wherein the network is a home network and wherein a Digital Living Network Alliance (DLNA) system resides on said home network.

10. A method according to claim 9, wherein said analyzing step is performed by a Media Interoperability Unit (MIU) connected to the home network, and wherein the MIU includes a decision handler that analyzes the metadata and the characteristics of the target device and a content adaptor that produces the content adaptation based on the rules or parameters set by the decision handler.

11. A method according to claim 10, wherein said acquiring step is accomplished by a set-top box arranged to receive digital cable television programs, and wherein said set-top box transmits the source multimedia digital content and associated metadata to the MIU.

12. A method according to claim 10, wherein said MIU transmits the encoded multimedia digital content to a wireless router which in turn transmits the encoded multimedia digital content to the target device.

13. A Media Interoperability Unit (MIU) for a Digital Living Network Alliance (DLNA) system, comprising:
a decision handling unit for receiving content metadata corresponding to source multimedia digital content and for analyzing the content metadata and determining rules or parameters for use in encoding the source multimedia digital content; and
a content adaptor for encoding the source multimedia digital content based on the rules or parameters determined for the source multimedia digital content by said decision handling unit.

14. A Media Interoperability Unit (MIU) according to claim 13, wherein said decision handling unit receives characteristics of a rendering device on which the encoded multimedia digital content is to be played and analyzes the render device characteristics when determining the rules or parameters for use in encoding the source multimedia digital content.

15. A Media Interoperability Unit (MIU) according to claim 14, further comprising an input connected to a Digital Living Network Alliance (DLNA) system for receiving the source multimedia digital content with associated content metadata and an output connected to the Digital Living Network Alliance (DLNA) system for transmitting an encoded multimedia digital content to the rendering device.

16. A Media Interoperability Unit (MIU) according to claim 13, wherein the decision handling unit is adapted for receiving source multimedia digital content of a television program with associated content metadata being from an Electronic Program Guide (EPG), wherein the decision handling unit analyzes a type of the television program and determines the rules or parameters based on the type of television program, and wherein rules and parameters determined by the decision handling unit includes at least one of frame rate, spatial quality and bit-rate.

17. A Media Interoperability Unit (MIU) according to claim 13, wherein said decision handling unit and content adaptor are implemented in software on a processor, a microprocessor, or a digital signal processor or are in the form of hardware.

18. A Digital Living Network Alliance (DLNA) system, comprising:
at least one Digital Media Server (DMS) for acquiring source multimedia digital content having associated content metadata;
at least one battery-operated, video-enabled, mobile device connected to the network and capable of receiving and playing multimedia digital content; and
a Media Interoperability Unit (MIU) for acquiring the source multimedia digital content and associated content metadata from said DMS and for transmitting an encoded adaptation of the source multimedia digital content to said mobile device;
said MIU having a decision handler for analyzing the content metadata and determining rules or parameters based on the content metadata for use in encoding the source multimedia digital content; and
said MIU having a content adaptor for encoding the source multimedia digital content based on the rules or parameters determined for the source multimedia digital content by said decision handler.

19. A Digital Living Network Alliance (DLNA) system according to claim 18, wherein said decision handler also receives characteristics of said mobile device on which the encoded adaptation of the source multimedia digital content is to be played and also analyzes the characteristics of said mobile device when determining the rules or parameters for use in encoding the source multimedia digital content.

20. A Digital Living Network Alliance (DLNA) system according to claim 18, wherein said DMS is a set-top box receiving source multimedia digital content corresponding to a cable television program with said associated content metadata being from an Electronic Program Guide (EPG), wherein said decision handler analyzes a type of the television program and determines the rules or parameters based on the type of television program, and wherein rules and parameters determined by said decision handler includes at least one of frame rate, spatial quality and bit-rate.

21. A Digital Living Network Alliance (DLNA) system according to claim 18, wherein said decision handler and content adaptor are implemented in software on a processor, a microprocessor, or a digital signal processor or are in the form of hardware.
